(19) United States
(12) Patent Application Publication
(10) Pub. No.: US 2003/0117497 A1
(43) Pub. Date: Jun. 26, 2003

(54) Communication terminal provided with a camera

(76) Inventors: Claus Nicolaisen, Copenhagen (DK); Maja Lund Pontoppidan, Copenhagen (DK); Morten Pontoppidan, Greve (DK); Peter Gorm Christensen, Copenhagen (DK); Lars Aresteen Madsen, Valby (DK); Romel Amineh, Umea (DK)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/023,715

(22) Filed: Dec. 21, 2001

(51) Int. Cl. H04N 5/225

(52) U.S. Cl. 348/207.99

(57) ABSTRACT

The invention relates to a communication terminal provided with a camera module. The communication terminal can be turned around it's axis to enable the camera module to take multiple pictures along the entire horizon. A vibrator motor in the communication terminal is used to turn the communication terminal and the camera module. The vibrator motor is also used to operate a lens cover to the camera module.

### BACKGROUND OF THE INVENTION

1. Field of the Invention

The present invention relates to a communication terminal, and in particular, where the communication terminal is provided with a camera module.

2. Description of Prior Art

In the development of mobile communication camera have been included in the terminals, either as an integrated part of the terminal or as a separate add-on or accessory device. An example of a communication terminal provided with a camera is the Samsung SCH-200 made for the Korean market. Other examples of communication terminals having are described in US2001/0020975, EP 0898 405 A and EP 0930 770 A2. In US2001/0020975 the camera module is provided as a separate module that is connected to the communication terminal via a headset jack socket connector and where the camera module can be rotated between different positions enabling the user to take different images. In EP 0898 405 A a foldable communication terminal is provided with a camera included in a hinge connecting the two foldable parts of the communication terminal. In EP 0930 770 A2 the camera module is provided as a separate part located on the top of the communication terminal, where the camera is vertically rotatable through 180 degrees about a vertical axis.

In yet another reference WO 01/31893 is described a communication terminal being provided with two camera modules that enables a user to take pictures of different objects at the same time.

According to the GSM standard it is specified that the standard GSM supplementary services is used for data transportation, e.g. a call or WAP browsing may the user may initiate an Unstructured Supplementary Service Data (USSD) Operation. This means that USSD uses a signalling channel as bearer for data transmission. The USSD is session-orientated, which means that when a user accesses a USSD service, a session is established and the radio connection stays open until it is released by the user, application or time-out can be used besides the call either during a call or out of call.

### SUMMARY OF THE INVENTION

The claimed invention provides a communication terminal having means for taking picture and control of the means for taking picture.

An object of the invention is to provide a communication terminal for enabling a user of the communication terminal to take pictures and to control the camera for taking pictures.

According to a first preferred embodiment of the claimed invention this objective is obtained by a communication terminal provided with a camera and a vibrator where the vibrator is used to control the camera in the communication terminal.

Another object of the invention is to provide a communication terminal provided with means for taking panorama pictures.

According to a second preferred embodiment of the claimed invention this objective is obtained by a communication terminal provided with a camera and a vibrator where the vibrator is turns the communication terminal and the camera provided in the communication terminal so that the camera can take a sequence of pictures.

A third object of the invention is to provide a communication terminal having means for protecting the camera provided in the communication terminal.

According to a third preferred embodiment of the claimed invention this objective is obtained by a communication terminal provided with a camera and a vibrator where the vibrator controls the movement of a slide cover covering a camera lens in the camera provided in the communication terminal.

A fourth object of the invention is to provide a communication terminal having means for enabling a first user to see the surroundings of a second user.

According to a fourth preferred embodiment of the claimed invention this objective is obtained by a communication terminal provided with a camera module where the camera could be controlled by a remote communication terminal during a call.

A fifth object of the invention is to provide a method for enabling a user of a communication terminal to take panorama pictures.

According to a fifth preferred embodiment of the claimed invention this objective is obtained by a method of enabling a user of a communication terminal provided with a camera, to control the operation of the camera where the communication terminal is further provided with a vibrator that the user uses to take multiple pictures with the camera.

A sixth object of the invention is to provide a method for enabling a user of a communication terminal having a camera to protect the camera from the surroundings.

According to a sixth preferred embodiment of the claimed invention this objective is obtained by a method of enabling a user of a communication terminal provided with a camera, to control a camera protection where the communication terminal is further provided with a vibrator that the user uses to move the camera protection between two positions.

A seventh object of the invention is to provide a method for enabling a first user to see the surroundings of a second user.

According to a sixth preferred embodiment of the claimed invention this objective is obtained by a method of enabling a user of a first communication terminal to control a camera module included in a second communication terminal, during a call between the communication terminals where a user of the second communication terminal controls a camera module included in the first communication terminal.

### BRIEF DESCRIPTION OF THE DRAWING

The invention will be explained more fully below, by way of example, in connection with preferred embodiments and with reference to the drawing, in which:

FIGS. 1-2 shows in a perspective view a known embodiment of a communication terminal.

FIG. 3 schematically shows the essential parts of a telephone for communication with a cellular network.

FIGS. 4a-c shows in a perspective view different embodiments of a communication terminal provided with a camera module.

FIGS. 5a-b shows a first embodiment of a mechanism for controlling opening and closing of a cover for the camera module.

FIGS. 6a-b shows a second embodiment of a mechanism for controlling opening and closing of a cover for the camera module

FIGS. 7a-b shows a third embodiment of a mechanism for controlling opening and closing of a cover for the camera module.

FIGS. 8a-b shows a fourth embodiment of a mechanism for controlling opening and closing of a cover for the camera module.

FIG. 9 shows a flowchart of the regulation system of the turning mechanism in the communication terminal.

FIG. 10 shows different displays of the communication terminal.

FIG. 11a shows a schematic drawing of a vibrator motor.

FIG. 11b shows an example of a cross section A-A of a part of the vibrator motor, where a cogwheel or the like is mounted to interface a camera cover controlling mechanism.

FIG. 11c shows a cross section B-B of a part of the vibrator motor, where a load is non-symmetrically mounted to establish the vibration motion.

FIGS. 12 a-b shows a communication terminal provided with a camera module in an upper part of the communication terminal.

FIG. 13 shows a flowchart of the system for enabling a remote communication terminal to control and operate a camera module.

### DETAILED DESCRIPTION OF THE INVENTION

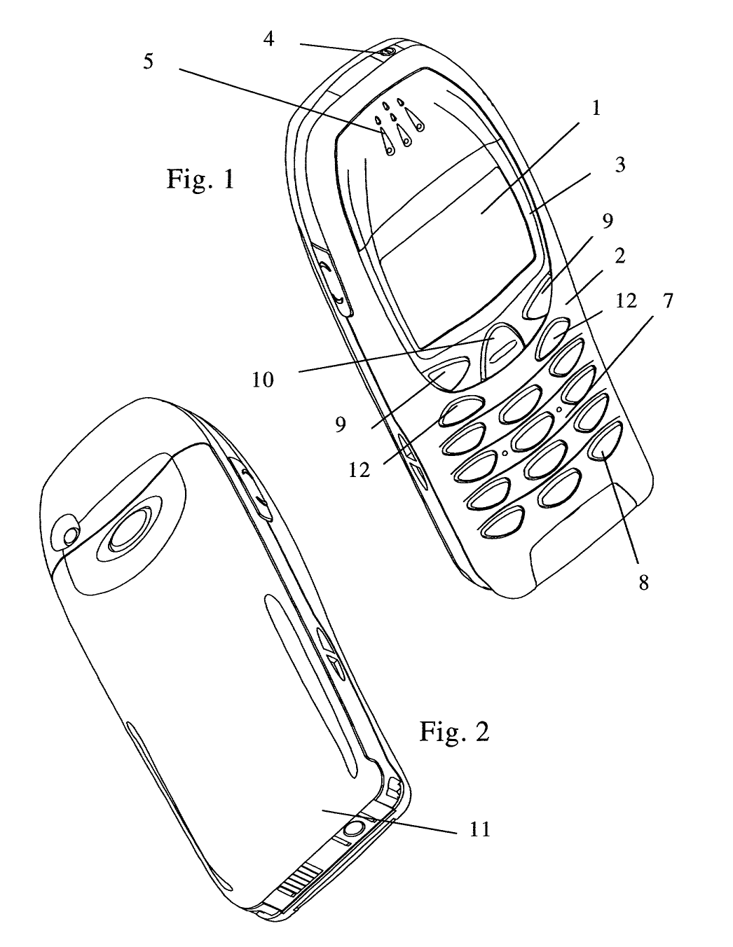

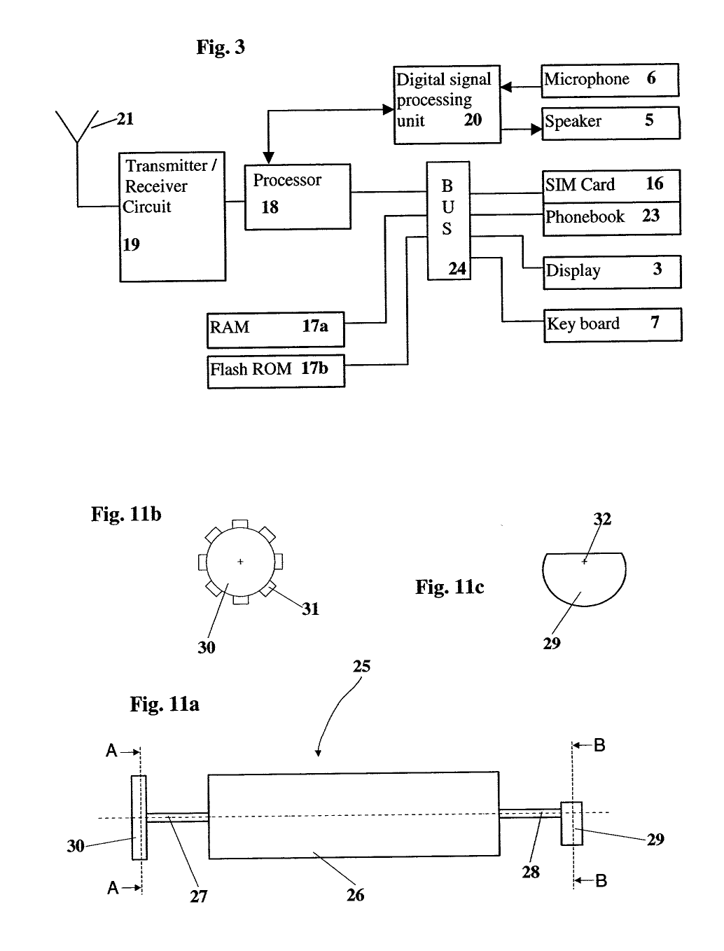

According to a first aspect the communication terminal provided with a camera according to the invention will be described with reference to a hand portable phone, preferably a cellular/mobile phone. An embodiment of this phone is shown in FIGS. 1-2, where a cellular/mobile phone 1 is shown in perspective. As will be seen, the phone is provided with a front cover 2 having a window frame 3 encircling the protection window of the display assembly 3. The cellular/mobile phone comprises a user interface having an on/off button 4, a speaker 5 (only openings are shown), a keypad 7, a battery 11, a display/LCD 3 and a microphone 6 (not shown).

The keypad 7 has a first group of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in text editing.

The keypad 7 additionally comprises two menu selection keys or soft-keys 9, two call handling keys 12, and a navigation-key 10. The functionality of the soft-key depends on the state of the phone and the navigation in the menu by using a navigation-key. The present functionality of the menu selection keys 9 is shown in separate fields in the display 3 just above the keys 9. The two call handling keys 12 are used for establishing a call or a conference call, terminating a call or rejecting an incoming call. This key layout is characteristic of e.g. the Nokia 6210™ phone.

The navigation-key 10 is an up/down key and is placed centrally on the front surface of the phone between the display 3 and the group of alphanumeric keys 8. Hereby the user will be able to control this key with his thumb. This is the best site to place an input key requiring precise motor movements. Many experienced phone users are used to one-hand handling. They place the phone in the hand between the fingertips and the palm of the hand. Hereby the thumb is free for inputting information.

FIG. 2 schematically shows the most important parts of a preferred embodiment of the phone/terminal, said parts being essential to the understanding of the invention. The microphone 6 records the user's speech, and the analogue signals formed thereby are A/D converted in an A/D converter (not shown) before the speech is encoded in an audio part 20. The encoded speech signal is transferred to a processor 18 (physical layer processor), which e.g. supports GSM terminal software. The processor 18 also forms the interface to the peripheral terminals of the apparatus, including RAM and ROM memories 17a and 17b, a SIM card 16, the display 3 and the keypad 7 (from FIG. 1) as well as data, power supply, etc. The processor 18 controls the communication with the network via the transmitter/receiver circuit 19 and an antenna 21. The audio part 20 speech-decodes the signal, which is transferred from the processor 18 to the speaker 5 via a D/A converter (not shown).

The processor 18 is via a bus 24 connected to a RAM memory 17a and a Flash ROM memory 17b, a SIM card 16, the display 3 and the keypad 7 (as well as data, power supply, etc.). A phonebook 23 is furthermore connected to the processor 18 via the bus 24. The phonebook 23 may be stored on the SIM card 16, and/or in the Flash ROM memory 17a.

The preferred embodiment of the communication terminal of the invention is adapted for use in connection with a GSM network, but, of course, the invention may also be applied in connection with other communication terminal networks. It could be cellular networks, various forms of cordless communication terminal systems or in dual band communication terminals accessing sets of these systems/networks.

The processor 18 is connected to the user interface of the mobile phone. Thus, it is the processor 18, which monitors the activity in the phone and controls the display 3 in response thereto.

Therefore, it is the processor 18, which detects the occurrence of a state change event and changes the state of the phone and thus the display text. The user may cause a state change event, when he/she activates the keypad 7 including the menu selection key or keys 9, and these types of events are called entry events or user events. However, the network communicating with the communication terminal may also cause a state change event. These type of events and other events beyond the user's control are called non-user events. Non user events comprise status change during call set-up, change in battery voltage, change in antenna conditions, message on reception of SMS, etc.

In FIG. 11a a vibrator motor 25 has been schematically shown. It includes a central part 26 containing the motor and being connected (not shown) to the PWB and the processor 18. The motor is provided with a left shaft 27 and to a right shaft 28. At the other end of the right shaft 28 a non-symmetrical load 29 is mounted. This load 29 is better shown is FIG. 11c, where a cross section B-B of the load in FIG. 11 is shown. The non-symmetrical shape of the load 29 is clearly viewed in relation to the centre 32 of the shaft 28. When the shaft 28 is rotated by the motor the non-symmetrical load 29 will establish the vibration motion, which as used for alerting the user of an incoming call or message. It can also be used for turning the communication terminal as later described in this application. A wheel 30 is at the end of left shaft 27, which not is connected to the motor. This wheel 30 is mainly used to interface and transfer motion to a camera cover controlling mechanism, i.e. to move a camera lens cover from a closed position to an open position and vice versa. The wheel 30 can transfer the motion in numerous ways like friction, a pinion, cogs etc. FIG. 11b shows an example of a cross section A-A of a part of the vibrator motor, where a cog-wheel 30 or the like is mounted to the end of the left shaft 28 to interface the camera cover controlling mechanism.

A first aspect of the invention is using an already existing vibrator motor in the communication terminal for executing additional functions. In this application it is suggested to use the vibrator motor for turning a communication terminal provided with a camera so that the camera is enabled to take a sequence of pictures that covers a view of 360 degrees round the position of the communication terminal. The vibrator motor can be used for such a purpose when it is located with a distance from the centre of gravity and the centre line of the communication terminal, i.e. the vibrations from the vibrator motor being in action will dislocate the mass of the communication terminal. This dislocation of the mass is according empirical studies a turning of the communication terminal around the centre of gravity or centre line of the communication terminal. The amount of turning is dependent upon of the weight of the communication terminal, the size of the vibrator counter-weight, the separation of the vibrator motor from the centre of gravity, the friction between the communication terminal and the surface thereon it is located and time of the vibration. A vibrator motor does not run continuously, but in intervals. The length of each interval affects the amount of turning of the communication terminal.

A standard software for evaluating pictures and putting a sequence of individual pictures together to one panorama picture is provided in the communication terminal. Such commercially available software compares the pictures to see where they overlap and thereby taking the essence from each picture and adding to a combined panorama picture. The software is also capable of defining the turning speed of communication terminal by the amount of overlap and the camera speed.

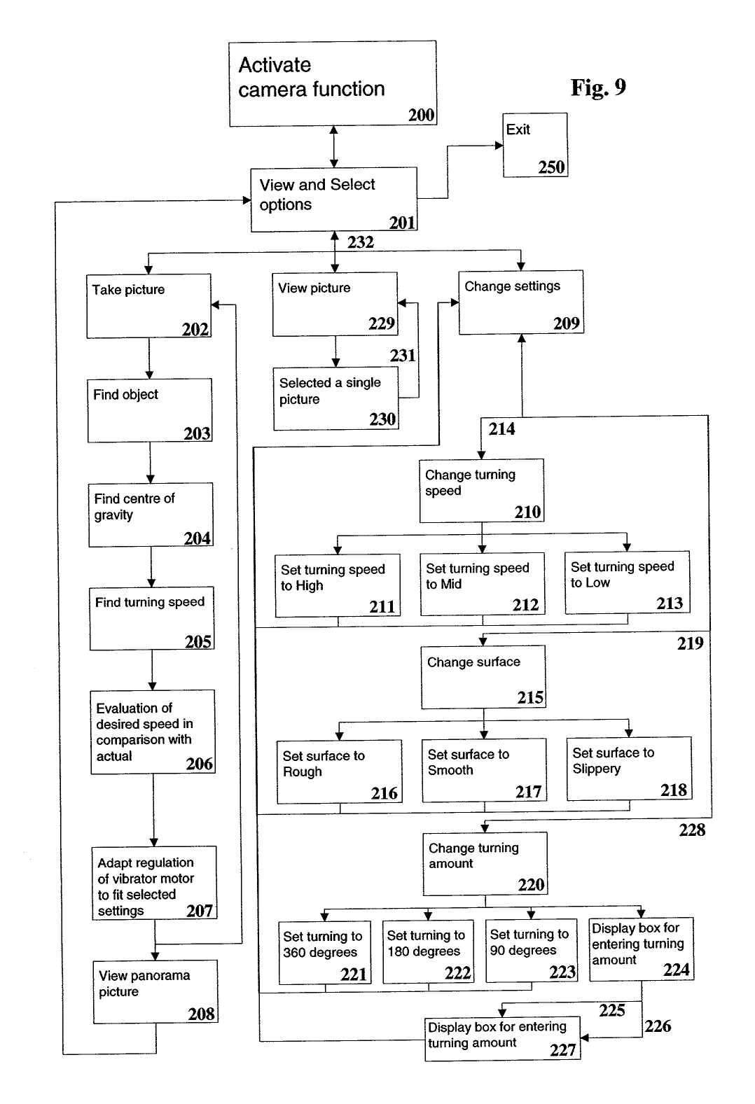

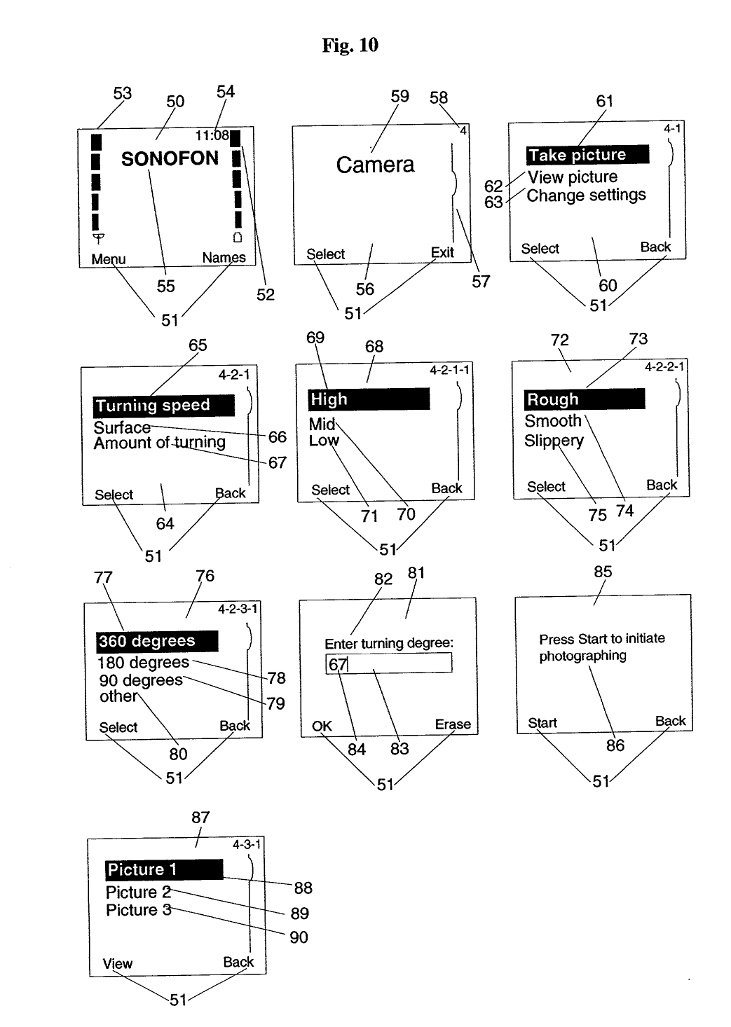

In a special menu (as shown in FIG. 10) a user of the communication will have a number of different options of how this camera function shall be performed by the communication terminal and its features. One of the options could be amount of turning that naturally affects the number of pictures taken in the sequence. A second option could be setting the viewing angle, i.e. should it be 360 degrees picture or should it be a different viewing angle. A third option could be adjusting the settings according to the characteristics of the ground surface on which the communication terminal is located. The steps of the camera menu are shown in FIG. 9 displaying a simplified flow-chart.

In FIG. 10 is shown an idle mode display 50 for the communication terminal or phone 1, which includes two bars indicating the signal strength 53 and the battery level 52. Furthermore there is a time indication 54, an identification 55 of the operator or the network to which the phone 1 is presently connected, and two labels 51 indicating the present function (Menu: access to the Menu structure; Names: access to the Phone book) of the two soft-keys 9.

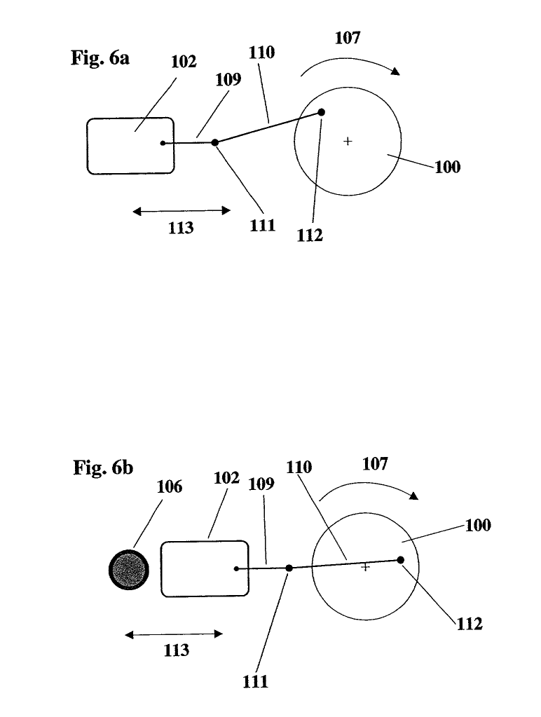

In a first embodiment of the invention, shown in FIG. 10, the camera function is located as one of the menus in the menu structure. In idle mode the user accesses the menu structure by pressing the left soft-key 9 “Menu”, shown in FIG. 6. A new display 56 will appear including a header 59 indicating the mode of the display (“Camera”), a menu-level indication 58 in the upper right comer and a picture (not shown) displaying a picture or the like that describes the function of the display menu. If other menus/functions are desired they can be displayed by scrolling down or up with the navigation-key 10 or if the “Camera” menu should be located in another place than the first position after idle mode. The menu-level indication 58 indicates the specified number of the menu currently being shown and can be used to short cut the way to that menu without scrolling in the menus with the navigation key 10.

To activate the camera function, step 200, the left soft-key 9 “Select” is pressed whilst in display 56, and a display 60 will appear, step 201. The display 60 includes a list of options 61-63. The first option 61 “Take picture”, which enables the user to take a picture, is selected by pressing the left soft-key 9, “Select”, step 202. After pressing the left soft-key 9, a display 85 will appear indicating with a header 86 that the photographing is started if the left soft-key 9, “Start”, is pressed yet another time. If the user regrets his choice he can return to display 60 by pressing the right soft-key 9, “Back”. The first option 61 “Take picture” might also be started by voice commands.

When the left soft-key 9, “Start”, has been pressed the processor 18 and the software for evaluating the sequence of pictures will initiate the photographing by taking a couple of pictures, step 202. These pictures are evaluated by the picture evaluating software, where the software finds objects on the pictures, step 203, and calculates the overlap between the pictures. The processor 18 decides the centre of gravity of the communication terminal, step 204. The picture overlap which correlates to the turning speed of the communication terminal is used to calculate the turning speed, step 205. This information is used to evaluate if the actual turning speed corresponds with the desired turning speed, step 206. The desired turning speed could be either a user selected speed or a pre-determined speed. The difference between the actual speed and desired speed might depend on the friction of the surface whereon the communication terminal is located. The user can select between a number of surface types to partly compensate for friction, and how the user can do this will be described later.

To change the actual turning speed so that is corresponds to the desired turning speed the vibrator motor will be adjusted. As earlier mentioned the turning speed or the amount of turning is depending on the vibrating intervals of the vibrator motor. The processor will with an electronic regulation adjust the vibrating intervals so that the desired turning speed is achieved, step 207. As the camera/communication terminal continues to take pictures as it turns the processor 18 and the software will continuously evaluate the turning speed and compare/adjust it in relation to the desired turning speed, step 202-207.

After the photographing is finished a first part of the panorama picture will be displayed (not shown) in the display of the communication terminal, step 208. Since the communication terminal shows a panorama picture it is not possible see the whole picture at the same time, and therefore the user can use the keypad for scrolling the picture. The user has however the possibility to select the amount of turning to be less than the whole horizon, which could mean that the picture can be viewed in total in the display. But for any other picture it is necessary to scroll to see the whole picture. In one example of using the alphanumeric keys 8 are e.g. the “2”-key used for up-scrolling, the “8”-key used for down-scrolling, the “4”-key used for left-scrolling and the “6”-key used for right-scrolling. After viewing the picture the user can take another picture by pressing the left soft-key 9, “New”, and a display 85 will appear again. A new panorama picture can be taken and viewed as earlier described, step 202-208. Other options can be viewed by pressing the right soft-key 9, “Back”, and display 60 will appear, step 200, where a second option 62, “View pictures”, and a third option 63, “Change settings”, are shown besides the earlier described first option 61 “Take picture”. Otherwise the camera function can be finished by yet another pressing of the right soft-key 9 “Back”, step 250, and the terminal is brought back to display 56 and other functions can be selected.

Any of option 62 or 63 can be select by scrolling down or up with the navigation-key 10, and pressing the left soft-key 9 “Select”, while the desired option is highlighted. The second option 62, “View picture”, is used for viewing already taken panorama pictures that are stored in the memory. When the second option 62 is selected, step 229, a display 87 will appear indicating a list of pictures 88-90. The list could naturally include more pictures than shown in display 87 and these be accessed by scrolling up or down the list with the navigation-key 10, and pressing the left soft-key 9 “Select”, while the desired picture is highlighted. When any of the pictures 88-90 are selected, step 230, with the left soft-key 9, “Select” the selected picture will be viewed in the display. Since the communication terminal shows a panorama picture it is not possible see the whole picture at the same time, and therefore the user can use the alphanumeric keys 8 for viewing the picture. One example of this is that the “2”-key used for up-scrolling, the “8”-key used for down-scrolling, the “4”-key used for left-scrolling and the “6”-key used for right-scrolling. The navigation-key 10 might also be provided with left and right options and could be used for viewing/scrolling the picture. After viewing the picture the user can view another picture by pressing the right soft-key 9, “Back”, and display 87 will appear, step 231. Another panorama picture can be selected and viewed as earlier described, step 230. If the right soft-key 9, “Back”, is pressed another time the communication terminal will be brought back to display 60, step 232, where the other options 61 and 63 can be selected.

The third option 63, “Change settings”, is used to change the settings of the photographing. When option 63 “Change settings” is selected, step 209, a display 64 will appear indicating a list of settings 65-67. The first setting 65, “Turning speed”, enables the user to select if the panorama picture shall contain a greater or lesser number of pictures. The camera takes a picture in a given interval and by increasing the turning speed the resolution of the panorama will be worse since it contains fewer pictures than with a lower speed. The second setting 66, “Surface”, enables the user to adjust the turning of the communication terminal to the surface characteristics of the surface. The friction of the surface will increase or decrease the turning speed of the communication terminal. The third setting 67, “Amount of turning”, enables the user to decide how large a portion of the horizon that the panorama picture should contain. Any of the three settings 65-67 can be selected by scrolling up or down the list with the navigation-key 10, and pressing the left soft-key 9 “Select”, while the desired setting 65-67 is highlighted.

If the first setting 65 is selected, step 210, a display 68 will appear indicating three different speed options 69-71. There could naturally be more options or an option that enables the user to more precisely decide the turning speed. The options in display 68 have however been limited to the three speed option 69-71 to simplify the presentation. If the first option 69, “High” as meaning high turning speed, is selected while being highlighted by pressing the left soft-key 9 “Select”, this option will be added to the controlling software and the communication terminal is brought back to display 64, step 211, where other changes to settings can be made. If the user yet another time selects the first setting 65, “Turning speed”, the display 68 will appear once more and the selected option will be highlighted. If the second option 70, “Mid” as meaning normal turning speed, is selected while being highlighted by pressing the left soft-key 9 “Select”, this option will be added to the controlling software and the communication terminal is brought back to display 64, step 212. Finally, if the third option 71, “Low” as meaning low turning speed, is selected while being highlighted by pressing the left soft-key 9 “Select”, this option will be added to the controlling software and the communication terminal is brought back to display 64, step 213. If no change of the preferred turning speed is desired the user can leave display 68 and the selection unchanged by pressing the right soft-key 9, “Back”, while being in display 68, step 214.

If the second setting 66, “Surface” is selected, step 215, a display 72 will appear indicating three surface options 73-75. There could naturally be more options or options more indicating the surface material like wood, metal, glass etc. that enables the user to more precisely decide the surface characteristics. The options in display 72 have however been limited to the three surface options 73-75 to simplify the presentation. If the first option 73, “Rough” as meaning a high friction surface, is selected while being highlighted by pressing the left soft-key 9 “Select”, this option will be added to the controlling software and the communication terminal is brought back to display 64, step 216, where other changes to settings can be made. If the user yet another time selects the second setting 66, “Surface”, the display 72 will appear once more and the selected option will be highlighted. If the second option 74, “Smooth” as meaning an average friction surface, is selected while being highlighted by pressing the left soft-key 9 “Select”, this option will be added to the controlling software and the communication terminal is brought back to display 64, step 217. Finally, if the third option 75, “Slippery” as meaning low friction surface, is selected while being highlighted by pressing the left soft-key 9 “Select”, this option will be added to the controlling software and the communication terminal is brought back to display 64, step 218. If no change of the preferred surface characteristics is desired the user can leave display 72 and the selection unchanged by pressing the right soft-key 9, “Back”, while being in display 72, step 219.

If the third setting 67, “Amount of turning” is selected, step 220, a display 76 will appear indicating four options 77-80. There could naturally be more or different options that enable the user to more precisely decide the amount of turning. The options in display 76 have however been limited to the four options 77-80 to simplify the presentation. If the first option 77, “360 degrees” as meaning the entire horizon, is selected while being highlighted by pressing the left soft-key 9 “Select”, this option will be added to the controlling software and the communication terminal is brought back to display 64, step 221, where other changes to settings can be made. If the user yet another time would select the third setting 67, “Amount of turning”, the display 76 will appear once more and the selected option will be highlighted. If the second option 78, “180 degrees” as meaning that half the horizon will be included in the panorama picture, is selected while being highlighted by pressing the left soft-key 9 “Select”, this option will be added to the controlling software and the communication terminal is brought back to display 64, step 222. If the third option 79, “90 degrees” as meaning that a quarter of the horizon will be included in the panorama picture, is selected while being highlighted by pressing the left soft-key 9 “Select”, this option will be added to the controlling software and the communication terminal is brought back to display 64, step 223.

Finally, if the fourth option 80, “other”, is selected while being highlighted by pressing the left soft-key 9 “Select”, a display 81 will appear, step 224. The display 80 includes a header 82 indicating “Enter turning degree:”, and a box 83 where the user can enter a desired amount of turning 84. The user uses the alphanumeric keys 8 to enter the amount of turning, step 225. An entered digit could be erased by pressing the right soft-key 9, “Erase”, step 226. If no digits have been entered into the box 83 the right soft-key 9, “Erase”, will bring the communication terminal back to display 76. After a desired amount of turning has been entered the left soft-key 9 “OK”, can be pressed and select the amount of turning that will be added to the controlling software and the communication terminal is brought back to display 64, step 227. If no change of the preferred turning amount is desired the user can leave display 76 and the selection unchanged by pressing the right soft-key 9, “Back”, while being in display 76, step 228. If nothing else is mentioned the turning will be clockwise, but the communication could either turn clockwise or counter-clockwise depending on the location of the vibrator motor in the communication terminal and the rotation direction of the weights on the vibrator motor.

If no change of the settings has been done the camera will compare the actual turning speed with the pre-determined turning speed as set by the manufacture of the communication terminal.

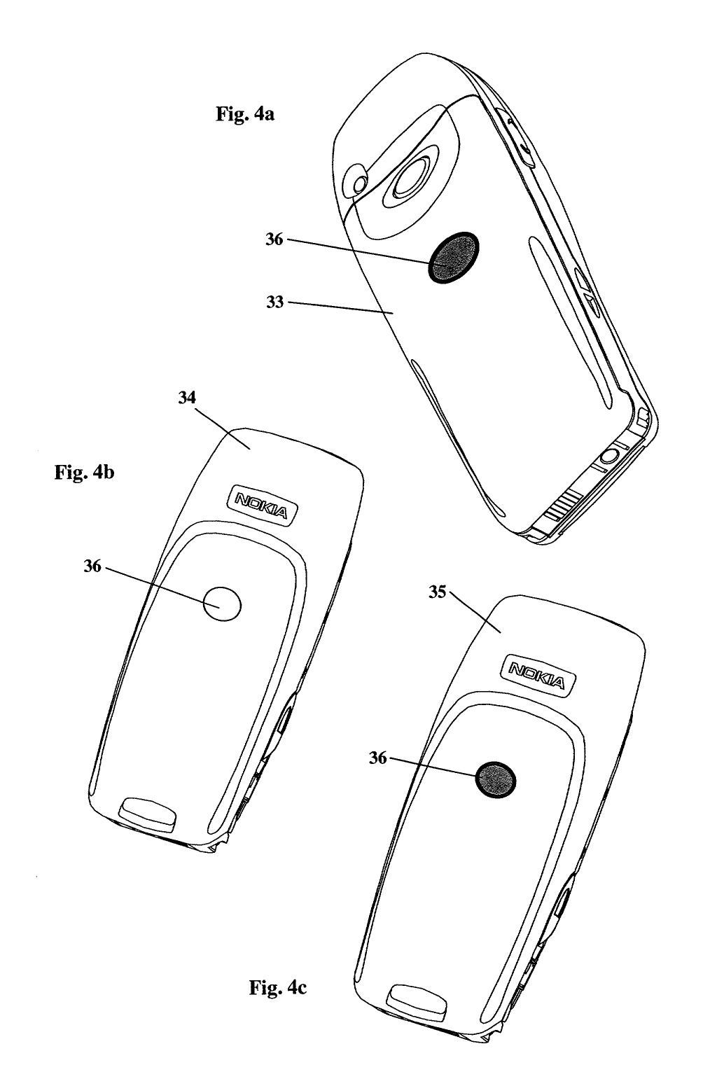

A second aspect of the invention is using an already existing vibrator motor in a communication terminal for more functions. In this application it is suggested to use the vibrator motor for moving a lens cover between two position, e.g. open and closed, for covering a camera lens in a communication terminal provided with a camera. In FIGS. 4a-c is shown different communication terminals 33, 34 and 35 provided with a camera module 36. In all of the communication terminals 33, 34 and 35 are the camera module 36 located in the back part of the communication terminals. In FIGS. 4a and 4c the camera lens is visible while in FIG. 4b the camera lens is covered by a lens cover.

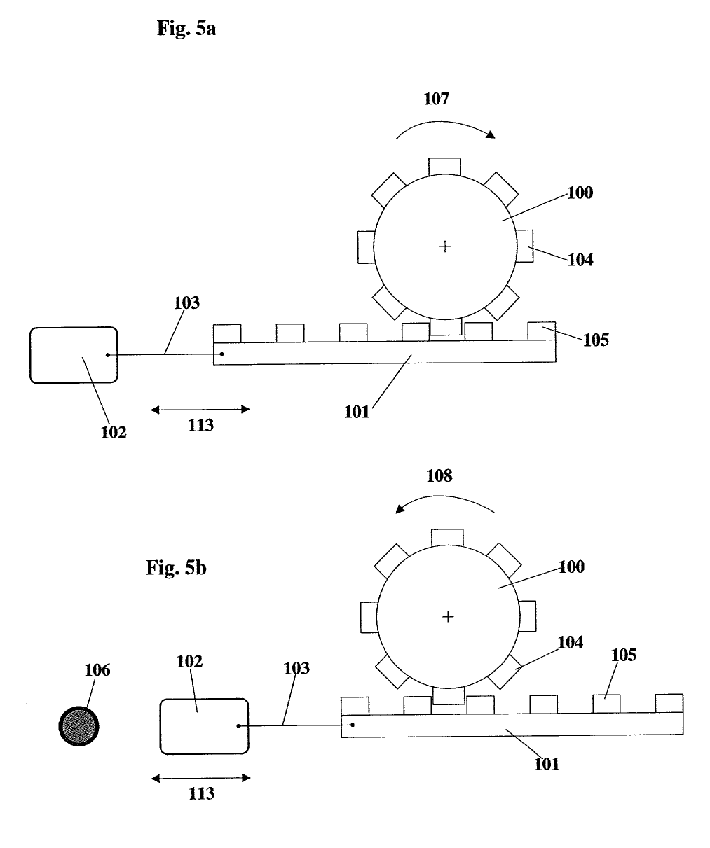

The mechanism for moving the lens cover can be designed in a vast number of variations. A couple of the possible variations or embodiments of the lens cover mechanism will be described below. The wheel used in the examples in FIGS. 5-8 for moving the lens cover could be the wheel 30 on the vibrator motor shaft 28 or a wheel interacting with that wheel 30 to transfer the motion from the vibrator motor 25.

A first embodiment of the mechanism for moving the lens cover has been shown in FIGS. 5a and 5b. The mechanism includes a cog-wheel 100, a rack 101, a cover 102 and a connection 103 between the rack 101 and the lens cover 102. The described mechanism has been simplified in that it does not include any bearing, holders etc. to just show the important parts in the mechanism. The cog-wheel 100 is provided with cogs 104 that interact with cogs 105 on the rack to transform the rotating motion (shown as directions 107 and 108) of the cog-wheel 100 to a linear motion 113 of the rack 101. In FIG. 5a the lens cover 102 is in one end position, the closed position, where the lens cover 102 protects the camera lens 106 (not shown in FIG. 5a). In FIG. 4b a part of the lens cover 102 is visible since the rest of the communication terminal is included, where only the centre part of the lens cover is visible. To move the lens cover from the first end position, the closed position, to the second end position, the wheel 100 will rotate in a counter-clockwise direction to move the rack 101 to the right in FIG. 5b. When the lens cover 102 is moved to the second end position, the open position, a camera lens 106 will be visible and the camera can be used. Both in FIGS. 4a and 4c are communication terminal shown having the lens cover 102 in the open position, where the camera lens is visible and the camera can the used. In FIG. 5a clockwise motion (shown as direction 107) of the cog-wheel 100 is used to move the lens cover 102 to the closed position and in FIG. 5b a counter-clockwise motion (shown as direction 108) is used to move the lens cover 102 to a open position. As it will later be described a clockwise motion 107 can be used for moving the lens cover to both a closed and an open position.

It could be preferable to use the same kind of motion, e.g. a clockwise motion, for moving the lens cover 102 between both the open position and the closed position. The reason for this is that the vibrator motor might create a vibrating motion even on the shaft 27 transferring the motion to the lens cover 102 since the non-symmetrical load 29 on the other shaft 28 will establish a rather powerful vibration. If the two shafts 28 and 29 could rotate independently of each other in opposite directions (107 and 108) this could be avoided since the shaft 28 would not rotate while the shaft 29 is rotating and vice versa. In the following examples the wheel 100 will rotate in one direction 107 independent if it is an opening or closing motion.

A second embodiment of the mechanism for moving the lens cover has been shown in FIGS. 6a and 6b. The mechanism includes a wheel 100, a cover 102 and a connection between the wheel 100 and the lens cover 102. The connection consists of a first link 109 and a second link 110 being connected to each other in a joint 111. The first link 109 is attached to the cover 102 in order to move the cover 102 from closed position to an open position and vice versa. The second link is attached to a pivot 112 on the wheel 100. There could naturally be more than two links in the connection between the cover 102 and the wheel 100. The described mechanism has been simplified in that it does not include any bearings, holders etc. but just shows the important parts of the mechanism. As the vibrator motor rotates the wheel 100 the link mechanism (109, 110, 111 and 112) will transform the rotating motion of the wheel 100 to a linear motion 113 of the cover 102. In FIG. 6a the lens cover 102 is in one end position, the closed position, where the lens cover 102 protects the camera lens 106 (not shown in FIG. 6a). To move the lens cover from the first end position, the closed position, to the second end position, the wheel 100 will rotate in a clockwise direction 107 to move the pivot 112 to be located to right from the centre of rotation as shown in FIG. 6b. When the lens cover 102 is moved to the second end position, the open position, a camera lens 106 will be visible and the camera can be used. In FIG. 6a clockwise motion 107 of the wheel 100 is used to move the lens cover 102 to the closed position and in FIG. 6b a clockwise motion 107 also is used to move the lens cover 102 to an open position.

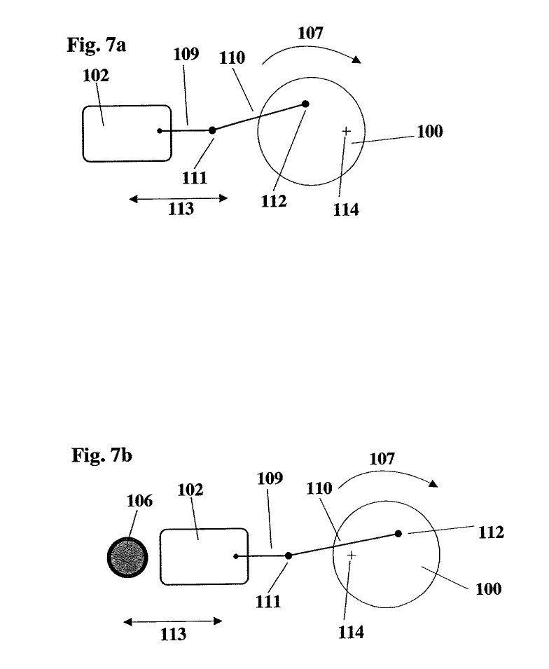

A third embodiment of the mechanism for moving the lens cover has been shown in FIGS. 7a and 7b. The mechanism includes a wheel 100, a cover 102 and a connection between the wheel 100 and the lens cover 102. The connection consists of a first link 109 and a second link 110 being connected to each other in a joint 111. The first link 109 is attached to the cover 102 in order to move the cover 102 from closed position to an open position and vice versa. The second link is attached to a pivot 112 on the wheel 100. The described mechanism has been simplified in that it does not include any bearings, holders etc. but just shows the important parts of the mechanism. The wheel 100 is not rotated around its centre, but around a dislocated point 114. As the vibrator motor rotates the wheel 100 around the point 114 the link mechanism (109, 110, 111 and 112) will transform the rotating motion of the wheel 100 to a linear motion 113 of the cover 102. In FIG. 7a the lens cover 102 is in one end position, the closed position, where the lens cover 102 protects the camera lens 106 (not shown in FIG. 7a). To move the lens cover from the first end position, the closed position, to the second end position, the wheel 100 will rotate in a clockwise direction 107 to move the pivot 112 to be located to the right of the rotation point 114 as shown in FIG. 7b. When the lens cover 102 is moved to the second end position, the open position, a camera lens 106 will be visible and the camera can be used. In FIG. 7a clockwise motion 107 of the wheel 100 is used to move the lens cover 102 to the closed position and in FIG. 7b a clockwise motion 107 also is used to move the lens cover 102 to an open position.

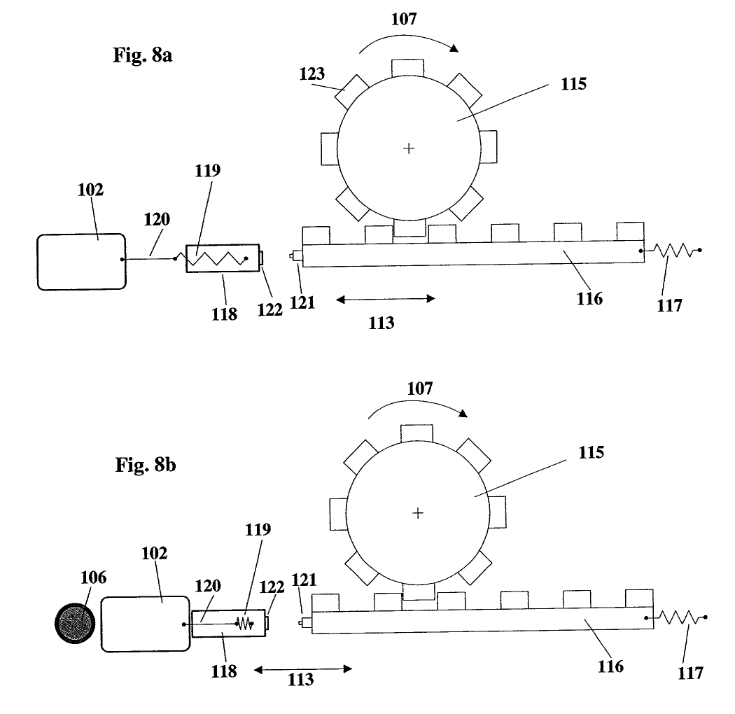

A fourth embodiment of the mechanism for moving the lens cover has been shown in FIGS. 8a and 8b. A first part of the mechanism includes a cogwheel 115, a rack 116, a trigger 121 and a spring 117. A second part of the mechanism includes a cover 102, a link 120, a spring 119, a housing 118 and a release button 122. The described mechanism has been simplified in that it does not include any bearings, holders etc. but just shows the important parts of the mechanism. The cog-wheel 115 is provided with cogs 123 that interact with cogs 105 on the rack to transform the rotating motion (shown as directions 107) of the cog-wheel 100 to a linear motion 113 of the rack 101. In FIG. 8a the lens cover 102 is in one end position, the closed position, where the lens cover 102 protects the camera lens 106 (not shown in FIG. 8a). To move the lens cover from the first end position, the closed position, to the second end position, the wheel 115 will rotate in a clockwise direction 107 to move the rack 116 to the left in FIG. 8b. When the rack 116 is moved to the left the trigger 121 will come into contact with the release button 122 that moves the housing 118 along with the rack 116 to compress the spring 120. As the rack 116 comes into an end position (not shown) the spring 119 is locked in a compressed state (as shown in FIG. 8b) and the rack 116 is returned its start position (shown in FIG. 8a) by the spring 117. When the lens cover 102 is moved to the second end position, the open position, a camera lens 106 will be visible and the camera can be used. To move the lens cover 102 to the closed position as shown in FIG. 8a clockwise motion (shown as direction 107) of the cog-wheel 115 is used another time, where the trigger 121 presses the release button 122 to unlock the spring 119 and the spring 119 moves the lens cover 102 to the closed position.

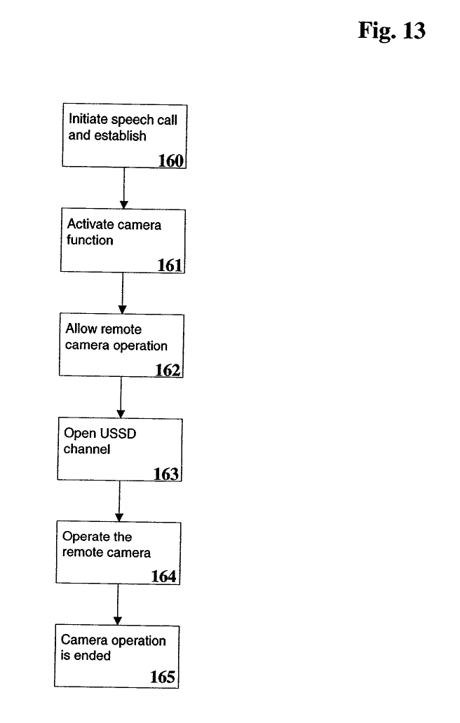

A third aspect of the invention is to enable a first user to see the surroundings of a second user. Here it is suggested that the camera function and the vibrator motor can be given input and controlled by another user, i.e. another communication terminal, by means of communication between two communication terminals. An example of this will now be described referring to a flowchart in FIG. 13.

A normal speech communication channel has been opened after a call has been initiated and established, step 160, between two communications terminals. After the normal speech communication is established the user can activate the camera function, step 161. Besides the settings 65-67 shown in FIG. 10 there could be another setting that allows remote camera operation. By selecting this setting, which can either be turned on or off, the user allows a remote communication terminal to control the camera operation, step 162. To enable the communication between the communication terminal another communication channel will be opened, step 163. It has earlier been described how a USSD signalling channel could be used as the supplementary communication channel for transmitting the data between two communication terminals. It is therefore proposed here to use the USSD channel as bearer for the control data of the camera or cameras between the two communication terminals. When the USSD channel has been opened, step 163, the user of the remote communication terminal can control and operate the camera, step 164. The user of the remote communication terminal uses his/her keypad or touch-pad to operate the remote camera. When the call is ended by anyone of the calling parts, the camera operation by the remote communication terminal is ended, step 165.

One could also think of using this kind of operation to remotely operate a camera for surveying, where a communication terminal provided with a camera module has been placed on place to be surveyed. The communication terminal has been set to automatically answer call from a certain number and allowing remote operation of the camera. As the communication terminal is called by the permitted caller a call will be established and the camera function activated. The remote caller uses his communication terminal to remotely control and operate the camera to survey the area where the communication terminal is located.

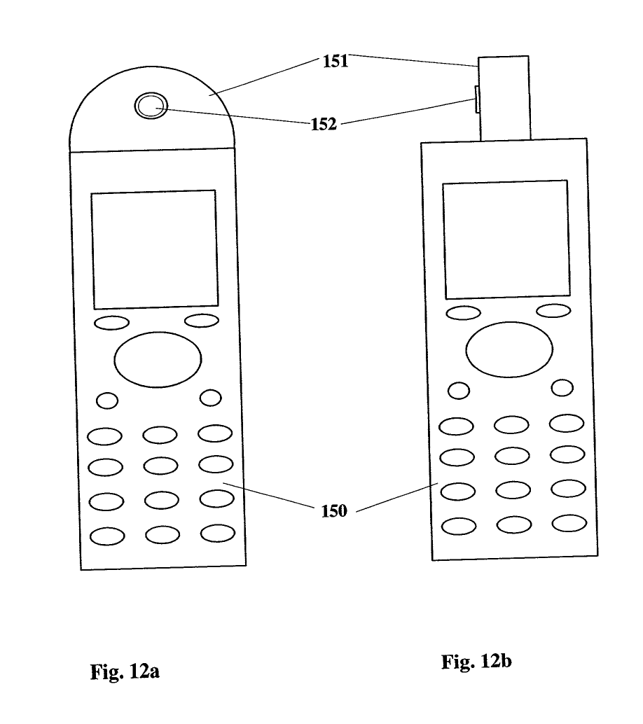

A fourth aspect of the invention is to provide a communication terminal with a camera module that can rotate in relation to the communication terminal. In FIGS. 12a and 12b a simplified drawing shows a communication terminal 150 provided with a camera module 152 in an upper part 151 of the communication terminal 150. The upper part 151 can rotate independently of the rest of communication terminal 150. A small motor (not shown) enables the rotation of the upper part 151. It might also be freely rotated manually by the user. It could be the vibrator motor that is used for rotating the upper part by the same solution as has been earlier described for the lens cover mechanism. It can also be a separate motor that is provided for rotating the upper part. When a user activates the camera function only the upper part 151 will rotate as the camera takes the pictures along the horizon to form a panorama picture. In FIG. 12a the camera module 152 is pointing in the same direction as the front of the communication terminal 150, while in FIG. 12b the upper part 151 and the camera module 152 is rotated 90 degrees in relation to the communication terminal 150.

The invention is not limited to the above-described examples or to the drawings showing examples of an embodiment, but can be varied within the scope of the appended claims. The communication terminal provided with a camera have in the shown embodiments two soft-keys, but also communication terminals having one, three or more soft-keys can be provided with the camera functionality according to the invention. The menu structure (not shown) of the communication terminal having a different number of soft-keys will be changed accordingly to suit the inventive concept.

What is claimed is:

1. A communication terminal provided with a camera and a vibrator wherein said vibrator is used to control the camera in said communication terminal.

2. A communication terminal according to claim 1, wherein said vibrator turns said communication terminal and said camera to enable said camera to take a sequence of pictures.

3. A communication terminal according to claim 2, wherein said communication terminal has different settings for manual selection to enable turning of said communication terminal and camera on different support surfaces.

4. A communication terminal according to claim 3, wherein said communication terminal has different settings to enable different amounts of rotation of said communication terminal and said camera.

5. A communication terminal according to claim 3 or 4, wherein said communication terminal is further provided with software to form a single picture from said sequence of pictures.

6. A communication terminal according to any preceding claim, wherein said software enables the user to define settings of said picture.

7. A communication terminal according to claim 1, wherein said vibrator controls the movement of a slide cover covering a camera lens in said camera.

8. A communication terminal according to claim 7, wherein the motor of said vibrator is provided with two shafts, where the first shaft has mounted an eccentric body thereon to create a vibrating effect while being turned, and where the second shaft has means for transferring the rotation of the shaft into a linear movement of the cover.

9. A communication terminal according to claim 8, wherein only one of the two shafts is rotated in dependence of the rotation direction of the vibrator motor.

10. A communication terminal according to claim 9, wherein said the wheel mounted on the said second shaft is a cogwheel.

11. A communication terminal according to claim 9, wherein said the wheel mounted on the said second shaft has an eccentric pivot.

12. A communication terminal according to claim 10 or 11, wherein said wheel mounted on the said second shaft affects an actuator connected to said slide cover, where the wheel enables said actuator to move said slide cover between two positions.

13. A communication terminal according to claim 12, wherein said actuator can be a rack, pinion, axle or a combination of them.

14. A communication terminal according to claim 1, wherein said camera can be controlled by a remote communication terminal during a call.

15. A communication terminal according to claim 14, wherein said camera is controlled by a keypad or touch-pad on said remote communication terminal during the call.

16. A communication terminal according to claim 15, wherein a USSD channel is used for transferring control signals of said camera.

17. A communication terminal provided with a camera module wherein said camera could be controlled by a remote communication terminal during a call.

18. A communication terminal according to claim 17, wherein said camera is controlled by a keypad or touch-pad on said remote communication terminal during the call.

19. A communication terminal according to any of claim 17 or 18, wherein said communication terminal is further provided with a vibrator, where said vibrator turns the communication terminal.

20. A communication terminal according to claim 16 or 19, wherein said vibrator turns the camera module of said communication terminal.

21. A method of enabling a user of a communication terminal provided with a camera, to control the operation of said camera, wherein said communication terminal is further provided with a vibrator that said user uses to take multiple pictures with said camera.

22. A method according to claim 21, wherein said vibrator turns said communication terminal when the camera takes pictures.

23. A method according to any of claim 21 or 22, wherein the user can set the turning speed of said communication terminal when the camera takes pictures.

24. A method of enabling a user of a communication terminal provided with a camera, to control a camera protection, wherein said communication terminal is further provided with a vibrator that said user uses to move said camera protection between two positions.

25. A method according to claim 24, wherein said camera protection is a cover and that said cover is moved between an open and a closed position in relation to said camera.

26. A method of enabling a user of a first communication terminal to control a camera module included in a second communication terminal, during a call between said communication terminals wherein a user of said second communication terminal controls a camera module included in said first communication terminal.

27. Method according to claim 26, wherein said communication terminals are provided with a control unit that receives input from the other communication terminal.
